(19) United States
(12) Patent Application Publication
(10) Pub. No.: US 2006/0220610 A1
(43) Pub. Date: Oct. 5, 2006

(54) Power management controller

(75) Inventor: Dean R. Solberg, Burlington, WI (US)

Correspondence Address: BRINKS HOFER GILSON & LIONE, P.O. BOX 10395, CHICAGO, IL, 60610, US

(73) Assignee: Kold Ban International, Inc.

(21) Appl. No.: 11/099,050

(22) Filed: Apr. 5, 2005

(51) Int. Cl. H02J 7/00

(52) U.S. Cl. 320/105

(57) ABSTRACT

A charging system includes cables, a switch, and a wireless receiver. A first cable is coupled to a vehicle to conduct current. A second cable is coupled to the vehicle to conduct a separate current. The switch is coupled to the first and second cables to control current flow to the vehicle. A wireless receiver coupled to the switch facilitates the flow of current to the vehicle when the wireless receiver receives an incoming signal from a transmitter. The method of charging a vehicle comprises coupling the switch to the first cable and the second cable; coupling a first and second boost module to the switch; coupling a controller to the first and second boost module to control the flow of current to the vehicle when a threshold voltage is detected; and coupling a wireless receiver to the switch to facilitate current flow to the vehicle when the wireless receiver receives an incoming signal and a correct polarity is detected.

### BACKGROUND OF THE INVENTION

2. Technical Field

The inventions relate to charging systems, and more particularly, to energy delivery systems that are capable of delivering current to a vehicle.

3. Related Art

The demand for electric power in passenger vehicles, cars, trucks, and buses is increasing. Engine management, audio, telematics, occupant safety, console, and other systems are consuming the power generated by a vehicle's electrical system. Many electric systems must support engine, body control, and interior systems when an engine is running. While a vehicle's charging system may support high electrical loads when the engine is running, when the engine is turned off, the parasitic drain of these loads may deplete the battery used to start that vehicle.

When a battery is dead or weakened, it is sometimes necessary to recharge the battery to a level that can be used to start a vehicle. One common way of recharging a battery is by jumping it with another battery. To jump a battery, a second battery is connected in parallel with the dead or weakened battery. The added battery may provide extra power to support the electrical loads and may provide the needed current to start the vehicle. Unfortunately, in some systems, the additional battery may not provide the needed current to support the engine load or ancillary loads of the other powertrain and in-vehicle systems. Moreover, the added battery may not provide the needed current for a sufficient period of time to start the vehicle. If it does not have sufficient power, the dead or weakened battery will draw power from the added battery. When connected for an extended period of time, the added battery may also become depleted.

Some supplemental supplies provide alternative sources of power to vehicles. In some devices, a low frequency transformer is used to step down an ac source to a lower voltage. The resulting secondary voltage is then converted into dc. The reduction in power dissipates energy in the form of heat, which lowers the efficiency of the charging system. Because of its low efficiency, some supplemental supplies need bulky and expensive heat sinks and cooling fans, which may decrease the output of the supply and create a bulky and heavy device that is difficult to use. Moreover, when a high current is needed, some supplemental supplies may not provide the needed current long enough to start a vehicle.

### SUMMARY

A charging system includes cables, a switch, and a wireless receiver. A first cable is coupled to a vehicle to conduct current. A second cable is coupled to the vehicle to conduct a separate current. The switch is coupled to the first and second cables to control current flow to the vehicle. A wireless receiver coupled to the switch facilitates the flow of current to the vehicle when the wireless receiver receives an incoming signal from a transmitter.

The method of charging a vehicle comprises coupling the switch to a first cable and a second cable; coupling a first and second boost module to the switch; coupling a controller to the first and second boost module to control current flow to a vehicle when a threshold voltage is detected; and coupling a wireless receiver to the switch to facilitate current flow to the vehicle when the wireless receiver receives an incoming signal and a correct polarity is detected.

Other systems, methods, features, and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The inventions can be better understood with reference to the following drawings and description. The components in the figures are not necessarily to scale, emphasis instead being placed upon illustrating the principles of the inventions. Moreover, in the figures, like referenced numerals designate corresponding parts throughout the different views.

FIG. 1 is a partial block diagram of a charging system.

FIG. 2 is a second partial block diagram of an alternative charging system.

FIG. 3 is a block diagram of a polarity detection warning system.

FIG. 4 is a block diagram of an optional re-charging system.

FIG. 5 is a flow diagram of a charging process of FIG. 1.

FIG. 6 is an alternative flow diagram of a charging process of FIG. 1.

FIG. 7 is a flow diagram of a recharging process.

FIG. 8 is a diagram of a mobile cart.

### DETAILED DESCRIPTION OF THE PREFERRED EMBODIMENTS

A portable charging system is capable of sourcing power to start a vehicle and support other vehicle systems. The system may provide one, two, or more separate voltage ranges. Some voltage ranges maybe suitable to start a vehicle such as a passenger vehicle (e.g., a car), a truck, a bus, or heavy duty vehicles. Other voltage ranges maybe suitable to turn on engine management, audio, telematics, occupant safety, consoles, and other systems or combinations of systems. The charging system may include a wireless interface, audio and/or visual reverse polarity protection, and a power management system.

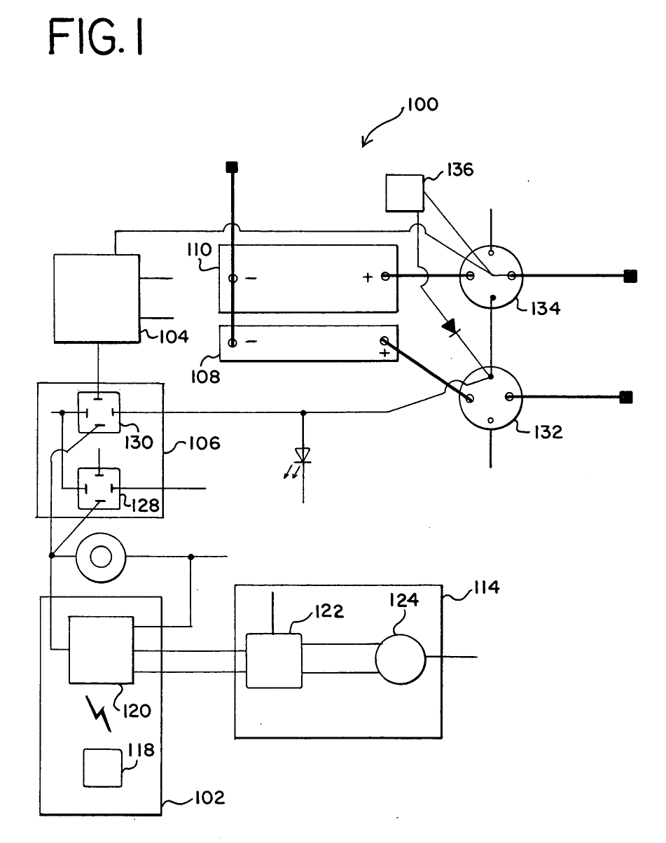

FIG. 1 is a partial block diagram of the portable charging system 100. The portable charging system 100 includes a wireless controller 102, a second controller or control module 104, electrical and mechanical switches, and a plurality of boost modules 108 and 110. The wireless controller 102 sends and receives data through radio, optical signaling (e.g., infrared) or some other technology or combination of technologies that do not require a physical connection between a transmitter 118 or a receiver 120.

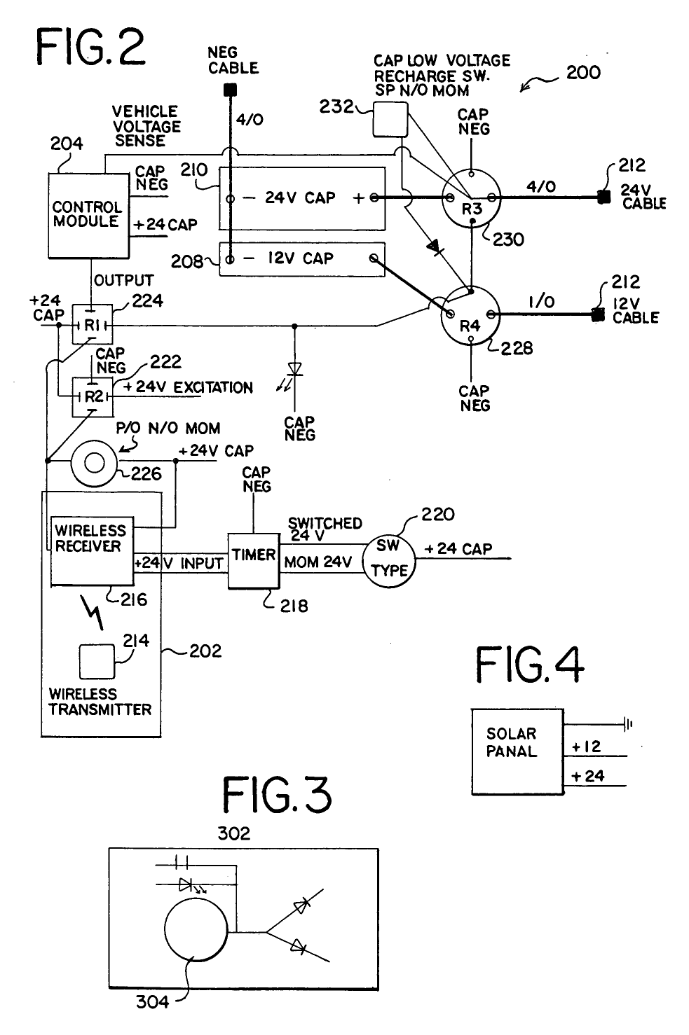

Power management elements 114 allow the wireless controller 102 to selectively shut-down when the portable charging system 100 is not in use for a period of time. The power management elements 114 provide three basic modes: active, idle, and sleep modes. In the active mode, the wireless controller 102 receives or transmits data. The power management elements 114 link a power source to a receiver 120. The link may connect one or more of the outputs of the boost modules 108 and 110 to an input of the receiver 120. The charging system 100 will also operate if a normally open push button switch or an equivalent, like the mechanical switch 226 shown in FIG. 2, is activated. When activated, power is sourced to one or more electrically activated switches even if power is removed or interrupted from the receiver 120. In idle mode, power continues to be supplied to the receiver 120. While the receiver 120 remains active, a standby timer 122 counts until the length of its count expires. The countdown length may be set by the user or defaulted to a system setting. In sleep mode, power is removed from the receiver 120 and the charging system 100 become inactive. Unlike the idle mode in which the charging system 100 may return to an active state when data is received from the transmitter 120, in some power management systems the portable charging systems 100 may only leave the sleep mode when the power management system is reset. In some systems, a two state element 124 such as a normally open momentary switch maybe used reset the power management system.

To provide power to an external source, the wireless receiver 120 receives the incoming signals and coverts them to a biasing signal that is fed to one or more electrically activated switches 106. In FIG. 1, a first switch 128 is turned on when the biasing signal is received, and it is turned off when the biasing signal is removed. When the first switch 128 is turned on, an excitation signal from one of the two boost modules 108 and 110 feeds to a second switch 130. When a relatively low-power signal is received from the control module 104, the excitation signal is routed to a third and a fourth switch 132 and 134 that are activated by the excitation signal.

A control module 104 coupled to an output of charging system 100 and the second switch 130 controls the states of the second, third, and fourth switches 130, 132, and 134. With or without input and output.isolation (e.g., such as through an opt-coupler), the control module 104 monitors an output of the charging system 100 and compares it against a fixed or a programmable voltage level or voltage range. When the voltage equals or rises above the voltage level or falls within the voltage range, the control module 104 activates the second switch 130 that couples one or more of the boost modules 108 and 110 to the outputs of the charging system 100. When the control module 104 detects a reverse polarity, the second switch 130 is deactivated effectively shutting down the charging system 100. A display and a device that converts electric signals into sound may warn a user of a reverse polarity connection.

In FIG. 1, the boost modules 108 and 110 are separate active energy storage elements. The energy storage elements may deliver current that is proportional to the rate of change of the voltage they store. A first boost module 108 may deliver a substantially smaller amount of current than the second boost module I 10. When the boost modules 108 and 110 are delivering current during a common time period, some second boost modules 110 may deliver a substantially larger current than some first boost modules 108. In some charging systems, the second boost module 110 delivers a boost current that is almost twice the boost current or greater than twice the boost current delivered by the first boost module 108.

To recharge the boost modules 108 and 110, the charging system 100 may include a two state device 136 that routes a load voltage and/or current to the control lines of the third and the fourth switch 132 and 134. A momentary switch, for example, may route a load voltage to the control node of an electromechanical switch. When a load voltage exceeds a predetermined voltage, that voltage may source power to the first and second boost modules 108 and 110 to re-charge them. When the output cables are coupled to a vehicle's electrical system, the vehicle's electrical power provides the control bias to the third and fourth switches 132 and 134 and the source power to recharge the first and second boost modules 108 and 110. In some alternative charging systems an optional power source, such as a solar panel or high frequency supply may be used to supplement the vehicle's charging system or may be used exclusively to recharge the first and second boost modules 108 and 110. In some charging systems, visual output devices display the state of the charging system 100 by providing details about the amount of current, voltage, and time, for example, of the charging and re-charging process. When an over-current or short-circuit condition arises, optional fuses or optional breakers in the output cable may bum out or open cutting off the flow of current between the charging system 100 and its load. In other charging systems, a current monitoring and limiting circuit within the control module 104 may deactivate the second switch 130 to protect the user and charging system 100 against high current and/or voltage conditions. In some systems, a display may identify the failure conditions.

FIG. 2 illustrates an alternative portable charging system 200. The alternative charging system includes a wireless control system 202, a controller 204, mechanical and electromechanical switches, a first and second boost module 208 and 210, and output interfaces 212. Radio waves are used for the wireless transmission of information between the wireless transmitter 214 and wireless receiver 216. The information maybe imposed on a carrier wave as amplitude modulation (AM) or a frequency modulation (FM) or in a digital form (pulse modulation). Transmission may not involve just a single-frequency transmission, but may rely on a frequency band whose width is dependent on the information density.

A register, software routine, or circuit, such as the timer 218 shown in FIG. 2 allows the portable charging system 200 to shut-down when not in use. A single pole double throw (switch, electromechanical relay, or solid state device) 220 provides complementary switching to reset the timer 218 and supply voltage from the boost module 210 to the timer 218. In an idle mode, the timer 218 counts until the length of its count expires. The countdown length maybe set by the user or defaulted to a system setting such as a fifteen or thirty minute interval. When the count expires, the charging system 200 enters a sleep mode. In the sleep mode, power is removed from the wireless receiver 216 and the charging system 200 becomes inactive. The charging system 200 will awaken if equipped with a normally open push button switch (e.g., such as the mechanical switch 226 shown in FIG. 2) or an equivalent that is activated. When the switch is closed, the charging system 200 will awaken even when power is removed from the wireless receiver 216.

To provide power to an external source, the wireless receiver 216 receives the incoming signal and converts them to a biasing signal that is fed to two electrically activated switches or relays 222 and 224. Alternatively, a mechanical switch 226, such as a normally open momentary switch positioned in parallel with the wireless receiver 216 may bias the switches or relays 222 and 224. In FIG. 2, a first relay 222 is turned on when the biasing signal is received from the wireless receiver 216 or the mechanical switch 226. When the first relay 222 is turned on an excitation signal from the boost module 210 is fed to the second relay 224. The second relay 224 routes the excitation signal to the third and fourth relays 228 and 230, when a control signal is received from the controller 204.

The output of the charging system 200 is monitored by a voltage and/or current monitoring circuit within the controller 204. Voltage and/or current monitored at the output interface 212 are compared against a fixed or programmed reference. When the output exceeds the reference, a control signal activates the second, third, and fourth relays 224, 228, and 230. When a reverse polarity connection is detected, the control signal does not flow from the controller 204, which deactivates the second relay 224 and shuts down the charging system 200. Analog gauges, digital, or light emitting diode displays 302 (as shown in FIG. 3) may provide a reverse polarity warning. A speaker or piezoelectric elements 302 may provide an audible warning to the user of a reverse polarity connection.

In FIG. 2, the first and second boost modules 208 and 210 comprise separate active circuit elements (e.g., capacitors or ultra capacitors) that store charge. The first and second boost modules 208 and 210 may comprise two or more KAPower™ super capacitors available from Kold Ban International of Lake In The Hills, Illinois. The first and second boost modules 208 and 210 may deliver the same or different current. In FIG. 2, the second boost module 210 is capable of delivering up to about twenty four volts of dc while the first boost module is capable of delivering up to about twelve volts of dc. In some charging systems the second boost module 210 is capable of providing the necessary amount of current to start a vehicle while the first boost module 208 is capable of sourcing an amount of current that can support powertrain and/or in-vehicle systems (e.g., electronic control modules, other engine management systems, consoles, etc). In some applications, the first boost module 208 may be used exclusively to start a vehicle having a 12 volt electrical system just as the second boost module 210 may be used to start vehicles having electrical systems greater than 12 volts. In these applications, the other boost module is not coupled to the vehicle's electrical system.

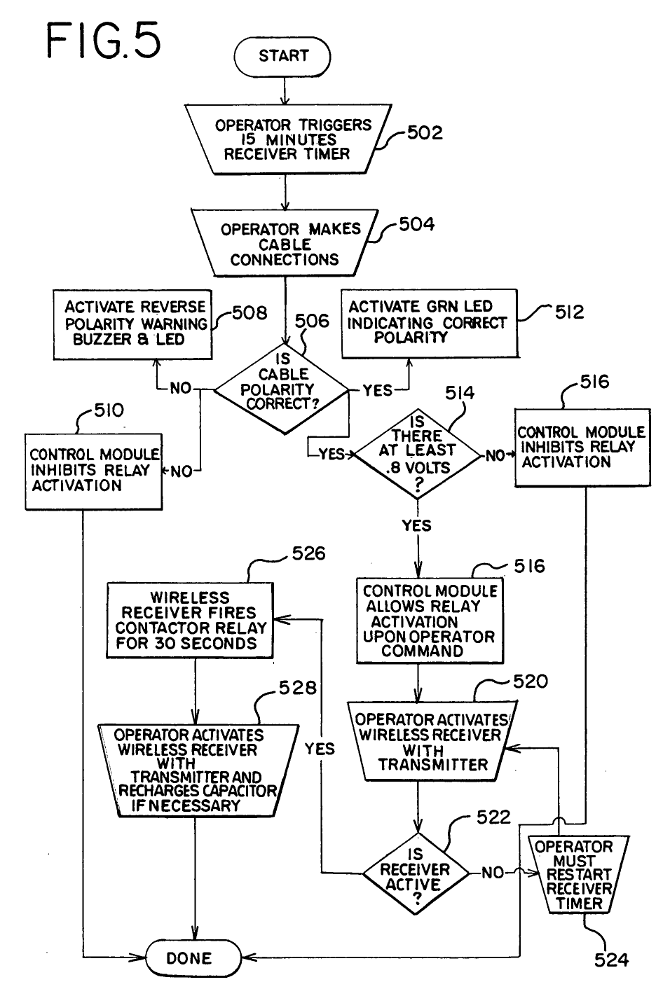

To recharge the first and second boost modules 208 and 210, the charging system 200 may include a mechanically activated switch 232, such as a normally open momentary switch that routes a load voltage to the control lines of the third and the fourth relays 228 and 230. When a load voltage exceeds a predetermined voltage, that voltage may source power to the first and second boost modules 208 and 210 to re-charge them. When the output cables are coupled to a vehicle's electrical system, the vehicle's electrical power provides the control bias to the third and fourth relays 228 and 230 and the source power to recharge the first and second boost modules 208 and 210. In some alternative charging systems an optional power source, such as a solar panel shown in FIG. 4 may be used to supplement the vehicle's charging system or may be used exclusively to fully recharge the first and second boost modules 208 and 210. In some charging systems, a screen displays the state of the charging system 200 by providing details about the amount of current, voltage, charging rate, and/or time, for example, of the charging and re-charging process. When an over-current or short-circuit condition arises, optional fuses or optional breakers in the output cable may bum out or open cutting off the flow of current between the charging system 200 and its load. In other charging systems, a current and/or voltage monitoring and limiting circuit within the control module 104 may deactivate the second relay 224 to protect the user and charging system 200 against high current and/or voltage conditions. In some systems, a screen may identify the failure conditions.

FIG. 5 is a flow diagram of a charging process that sources power to a vehicle's electrical system using a wireless control system. At act 502, an operator programs a timer or activates the timer. At act 504, the operator couples the charging cables to a vehicle. The connection may comprise connecting one or both output cables to separate or common elements of the vehicle's battery or electrical system. By monitoring the output the polarity of the connection can be assured. If a reverse polarity connection is detected at act 506, a visual and/or audible warning is provided at act 508, and a controller inhibits the charging process at act 510.

When polarity is assured at act 506, a display, which may include a bipolar light emitting diode, will confirm a proper connection at act 512. An output is then monitored and compared against a voltage reference (e.g., about eight tenths of a volt) or range at act 514. If the vehicle voltage falls within a voltage range or is less than a predetermined reference voltage, such as about eight tenths of a volt, for example, the charging process terminates at act 516. However, if the vehicle voltage is greater than the predetermined voltage, the charging system enters an active mode in which power is supplied to a wireless receiver at act 516.

An operator can couple one or more of the boost modules to the vehicle's battery or electrical system by activating a wireless transmitter (or transceiver). While the range of the transmitter may send electrically encoded data to a receiver from any distance such as from up to about two-hundred feet away, some transmitters may convey data to the remote receivers from about seventy-five feet away from the receiver at act 520. If the receiver is found to be asleep at act 522, the operator must re-program the timer or activate the timer at act 524 If the receiver is in an active or idle mode, it receives the incoming signals and converts them to a control signal that couples the one or more boost modules to the vehicle's battery or electric system for a predetermined period (e.g., about thirty seconds) of time at act 526. If additional charging is needed, the operator may re-couple one or more of the boost modules to the vehicle's battery or charging system by re-activating the wireless transmitter (or transceiver). In some exemplary charging systems, one boost module may source a current range of about one to four hundred amps and a second boost module may source about ten to about six thousand amps. Other exemplary charging systems may source any current range from between about a quarter of an amp to about six thousand amps.

To recharge the boost modules, an operator may activate the wireless receiver be sending electrically encoded data or may manually activate a switch coupled to the vehicle's battery or electrical system. A switch may route the vehicle voltage to the boost modules at act 528.

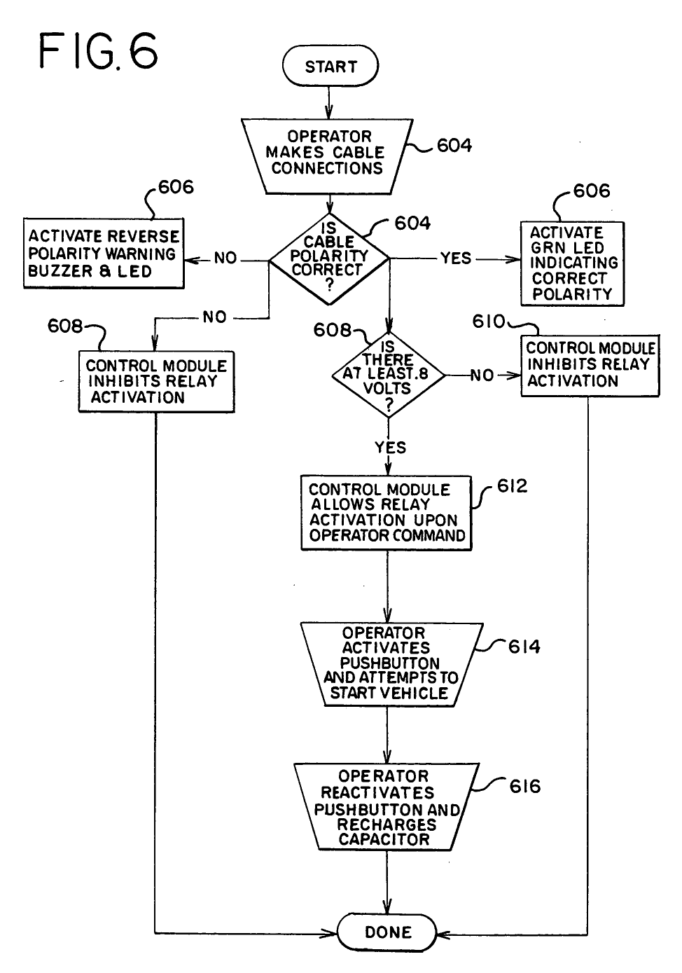

FIG. 6 is an alternative flow diagram of a charging process the may source power to a vehicles battery using manual control. At act 604, the operator couples the charging cables to a vehicle. The connection may comprise connecting one or both output cables to separate or common elements of the vehicle's battery or electrical system. By monitoring the output the polarity of the connection can be assured. If a reverse polarity connection is detected at act 604, a visual and/or audible warning is provided at act 606, and a controller inhibits the charging process at act 608.

When polarity is assured at act 604, a display, which may include a bipolar light emitting diode, will confirm the proper connections at act 606. An output is then monitored and compared against a voltage reference (e.g., about eight tenths of a volt) or range at act 608. If the vehicle voltage falls within a predetermined voltage range or is less than a predetermined reference voltage, such as when it less than about eight tenths of a volt, for example, the charging process terminates at act 610. However, if the vehicle voltage is greater than the predetermined voltage, the charging system enters an active mode in which a controller module allows an operator to automatically couple one or more boost modules to a vehicles battery or electrical system at act 612.

An operator may couple one or more of the boost modules to the vehicle's battery or electrical system by activating a mechanical or electromechanical switch. When the switch is activated, the charging system couples the boost modules to the vehicle's battery or electric system for a predetermined period of time at act 614. If additional charging is needed, the operator may re-couple one or both of the boost modules to the vehicle's battery or charging system by re-activating switch.

To recharge the boost modules, an operator may activate the switch or a second switch coupled to the vehicle's battery or electrical system at act 616. The switch may route the vehicle voltage to the boost modules to recharge them.

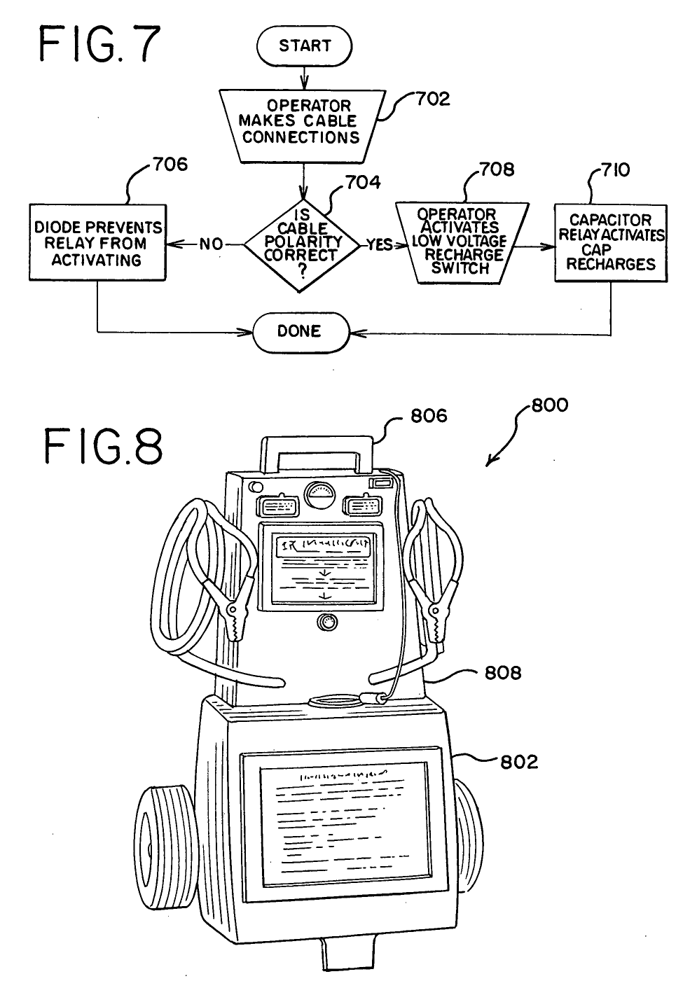

FIG. 7 is a flow diagram of the recharging process. At act 702, the operator couples the charging cables to a vehicle. The connection may comprise connecting one or both output cables to separate or common elements of the vehicle's battery or electrical system. By monitoring the output, the polarity of the connection can be assured. If a reverse polarity connection is detected at act 704, a visual and/or audible warning maybe provided, and a circuit element or controller inhibits the re-charging process.at act 706. To recharge the boost modules, an operator activate the switch coupled to the vehicle's battery or electrical system at act 708. The switch may route the vehicle voltage through a relay to re-charge the boost modules at act 710.

The current that flows into the boost modules may have certain features. Unlike a resistive current, the re-charging current may not be proportional to the voltage rating of the boost modules, but rather to the rate of change of the voltage of the boost modules. Moreover, unlike the current that flows through a resistor, the power associated with the re-charging current is not turned into heat, but is stored as energy. Also, the impedance of the boost modules may change with the output frequency of the charging source. Moreover, when the boost modules are discharged in some charging systems, almost all of the energy is sourced back when the boost modules are discharged.

The portable charging systems may be embodied in many types of enclosures. A mobile cart, having two or more wheels, for example, maybe used to transport the portable charging system. An exemplary mobile cart 800 may include a rectangular storage enclosure 802 coupled to the two inflatable wheels shown in FIG. 8 or to one or more rigid wheels. The portable charging system may be contained within an electrically insulated storage enclosure 802 or may be distributed between the storage enclosure 802 and a handle 806. In FIG. 8, a rectangular handle 806 couples an electrically insulated stem 808. A front or rear panel that comprises part of the enclosure 802 or stem 808 provides access to the charging system. While the storage enclosure 802 and stem 808, respectively, have vertical and horizontal lines of symmetry, other shapes, and symmetries may be used in alternative mobile carts. Moreover, the mobile cart 800 may be made of other materials including other insulating materials, such as a non-conductor of heat. Other housing without wheels may also be used to store or carry the charging systems.

The portable charging systems maybe capable of sourcing power multiple voltage levels to a vehicle. By using separate charging modules (e.g., spaced apart boost modules) in some charging systems, all of the functionality of the boosting system is not lost when a boost module and/or certain output switches fails. For example, if a first boost module were to fail (e.g., may not hold a charge or is not rechargeable), all of the functionality of some of the charging systems is not lost. In these systems, a second (and/or a third, and/or a fourth boost module, etc.) will still operate even when the first boost module fails.

The term charging is intended to broadly encompass mechanisms and methods that source a current and/or voltage that is capable of starting a vehicle as well as other mechanisms and methods that may supplement another power source within or coupled to a vehicle.

The above described charging systems may provide one, two, or more separate voltage ranges. Some voltage ranges maybe suitable to start a vehicle such as passenger vehicles, cars, trucks, buses, construction, or other vehicles. Other voltage ranges maybe suitable to support engine management, audio, telematics, occupant safety, consoles, and other systems or combination of systems. The charging system may include a wireless interface, audio and/or visual reverse polarity protection, and a power management system.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A charging system comprising:
a first cable configured to conduct current to a vehicle;
a second cable configured to conduct a separate current to the vehicle;
a switch coupled to the first cable and the second cable that controls current flow to the vehicle; and
a wireless receiver coupled to the switch that facilitates the flow of current to the vehicle when the wireless receiver receives an incoming signal from a transmitter.

2. The system of claim 1 further comprises a first boost module that provides a boost current and a second boost module, separate from the first boost module that provides a second boost current.

3. The system of claim 2 where the second boost module delivers a substantially larger current to the vehicle than the first boost module.

4. The system of claim 2 where the first boost module and the second boost module are separate active energy storage elements.

5. The system of claim 4 further comprising a controller coupled to the first boost module and the second boost module that allows current to flow to the vehicle when a threshold voltage is detected through the first cable.

6. The system of claim 5 where the control module is configured to monitor a potential difference between the first cable and a reference and is further configured to shut down the charging system when a reverse polarity connection is detected.

7. The system of claim 2 further comprising power management elements that selectively shuts-down the charging system when the charging system is not in use for a predetermined amount of time.

8. The system of claim 7 where the power management system comprises an idle mode in which power is sourced to the wireless receiver until a count tracked by a circuit element expires.

9. The system of claim 8 where the power management system further comprises a mechanical switch coupled to the circuit element that awakens the charging system when the charging system is in a sleep mode.

10. The system of claim 2 further comprising a first electromechanical switch and a second electromechanical switch coupled to the switch and the first cable and the second cable, respectively.

11. The system of claim 10 further comprising a switch coupled the first electromechanical switch and a second electromechanical switch where the switch controls the signal flow through the first electromechanical switch and a second electromechanical switch.

12. A charging system comprising:
a first cable for conducting current to a vehicle;
a second cable for conducting a separate current to the vehicle;
a switch coupled to the first cable and the second cable that controls current flow to the vehicle;
a first boost module coupled to the switch for providing a first boost current;
a second boost module, separate from the first boost module, for providing a second boost current;
a controller coupled to the first boost module and the second boost module that allows current to flow to the vehicle when a threshold voltage is detected; and
a wireless receiver coupled to the switch that facilitates current flow to the vehicle when the wireless receiver receives an incoming signal from a transmitter and an expected polarity is detected.

13. The system of claim 12 where the second boost module is capable of delivering a substantially greater current to the vehicle than the first boost module.

14. The system of claim 12 where the controller comprises a current monitoring and limiting circuit configured to inhibit the switch when an over-current condition arises.

15. The system of claim 12 where the controller comprises a current monitoring and limiting circuit configured to inhibit the switch when a short-circuit condition arises.

16. The system of claim 12 where the first boost module and the second boost module are discharged and recharged by the vehicle.

17. The system of claim 12 where the switch comprises a relay.

18. The system of claim 12 where the first and the second boost modules comprise ultra-capacitors.

19. The system of claim 12 further comprising a screen for displaying charging or re-charging parameters.

20. A method of charging a vehicle's electrical system comprising:
coupling a switch to a first cable and a second cable;
coupling a first boost module that provides a first boost current to the switch;
coupling a second boost module that is separate from the first boost module that provides a second boost current to the switch,
coupling a controller to the first boost module and the second boost module that allows current to flow to the vehicle when a threshold voltage is detected; and
coupling a wireless receiver to the switch to facilitate the flow of current to the vehicle when the wireless receiver receives an incoming signal from a transmitter and a correct polarity is detected.
